(19) United States
(12) Patent Application Publication
(10) Pub. No.: US 2002/0154223 A1
(43) Pub. Date: Oct. 24, 2002

(54) Locking apparatus of vibration proof lens for camera, vibration proof adapter, and lens apparatus

(76) Inventor: Chikatsu Moriya, Saitama-shi (JP)

Correspondence Address: BIRCH STEWART KOLASCH & BIRCH, PO BOX 747, FALLS CHURCH, VA, 22040-0747, US

(21) Appl. No.: 10/124,316

(22) Filed: Apr. 18, 2002

(30) Foreign Application Priority Data
Apr. 20, 2001 (JP) 2001-122832

(51) Int. Cl. H04N 5/225

(52) U.S. Cl. 348/208.11; 348/208.99

(57) ABSTRACT

The locking apparatus of a vibration proof lens automatically unlocks a movable vibration proof correction lens (a vibration proof lens) when electric power is applied, and automatically locks the lens at power-down, thereby eliminating a lock operation of the user and improving safety at the time of conveyance. The vibration proof lens and the locking apparatus thereof are mounted in a vibration proof adapter mounted between a television camera body and a lens apparatus, or a lens apparatus body. A power supply detection device detects that a camera power supply or an external power supply is connected and power is applied to vibration proof circuits, and activates a driving system such as an actuator to release a lock mechanism. On the contrary, when detecting that power supply becomes OFF, the power supply detection device activates the lock mechanism through the driving system to lock the vibration proof lens.

### BACKGROUND OF THE INVENTION

1. Field of the Invention

The present invention relates to a locking apparatus of a movable lens (hereinafter referred to as a vibration proof lens) that optically corrects image blurring generated by vibration applied to a camera, a vibration proof adapter, having the locking apparatus, and a lens apparatus.

2. Description of the Related Art

When a television camera etc. is used on an outdoor sport relay broadcast or an unstable scaffold, a lens apparatus and a detachable vibration proof adapter equipped with a vibration proof lens which optically corrects image blurring generated by vibration are used. The vibration proof lens is movably supported in a plane orthogonal to an image-taking optical axis inside a lens barrel of a camera, or an adapter, and driven if vibration is applied to a camera, will be driven with an actuator etc. in the direction which compensates the vibration, and will correct image blurring.

In this kind of vibration isolator, it is possible to control so as to locate a vibration proof lens in a predetermined place by an actuator operating during power-up. Nevertheless, since a control line is disconnected during power-down, a vibration proof lens freely moves. In this state, not only it becomes impossible to maintain an optical axis, but also there happens a problem of a lens being damaged by vibration or impact at the time of transportation.

In order to solve this problem, up to now, a lock mechanism fixing a vibration proof lens at a predetermined position is provided in the vibration isolator. The lock mechanism mentioned in Japanese Patent Application Publication No. 2000-2901 holds a lens retention frame of a vibration proof lens in sandwich manner by rotationally operating an operation ring to lock the vibration proof lens to a lens barrel. However, the lock mechanism disclosed in the Japanese Patent Application Publication No. 2000-2901 has a possibility that the vibration proof lens is unlocked when the operation ring is accidentally moved during conveyance of a lens apparatus etc.

Moreover, the lock mechanism mentioned in Japanese Patent Application Publication No. 2000-39638 holds a lens retention frame of a vibration proof lens by performing the slide operation of a lock ring to lock the vibration proof lens to a lens barrel. However, it is assumed that the lock mechanism disclosed in Japanese Patent Application Publication No. 2000-39638 is conveyed with the vibration proof lens securely locked, by attaching a lens cap to the lens barrel. Nevertheless, there is a problem that the locked state of the vibration proof lens is not guaranteed if it is forgotten to attach the lens cap.

Furthermore, in these lock mechanisms, since it is necessary to lock or unlock the vibration proof lens by operating the operation ring or the lock ring whenever the lens apparatus is detached from or attached to a camera body, it is desired to improve operability.

### SUMMARY OF THE INVENTION

The present invention is devised in view of such a situation, and its object is to provide an automatic locking apparatus that not only can securely lock a vibration proof lens at the time of transportation etc., but also does not require the lock/unlock operation of the user. Another object is to provide a vibration proof adapter and a lens apparatus in each of which the locking apparatus is mounted.

In order to attain the above-described objects, the present invention is directed to a locking apparatus for locking a vibration proof lens which is moved to correct image blurring caused by vibration applied to a camera, the locking apparatus comprising: a power supply detection device which detects whether a power supply is connected to a drive circuit activating the vibration proof lens; and a locking device which enables the vibration proof lens to move by moving a locking member to a release position if the power supply detection device detects that the power supply is ON while disabling the vibration proof lens to move by moving the locking member to a lock position if the power supply detection device detects that the power supply is OFF.

According to the present invention, it is not necessary for the user to operate a lock mechanism since a locking member of a vibration proof lens is automatically driven to a release position/lock position by interlocking with ON/OFF of a power supply. Hence, not only operability improves, but also misoperation at the time of conveyance is prevented, and hence safety improves.

The locking device may comprise a solenoid used as an electrically driving device to move the locking member. When electric current flows in the solenoid at power-up, a movable iron core (plunger) is drawn, and owing to this operation, the locking member is moved to a release position. On the other hand, the plunger returns to a projection position (initial position) at power-down, and a locking member is moved to a lock position.

The locking device may comprise: a motor used as electrically driving device which moves the locking member; and one of a capacitor and a battery used as an electric power-supplying device which activates the motor at power-down. While driving the motor in the unlock direction by the power supply concerned at power-up, the motor is driven in the lock direction at power-down by using a battery or the discharge of a capacitor which is charged during power-up.

Preferably, the locking apparatus further comprises a forcibly locking device which prohibits unlock operation of the locking device in response to a user's operation at power-up, and at the same time, forcedly achieves a locked state by moving the locking member to the lock position. Thus, since it is possible to lock a vibration proof lens even at power-up if needed, this is convenient in manufacturing adjustment etc.

The present invention is also directed to a vibration proof adapter, in which the locking apparatus of a vibration proof lens for a camera, and the vibration proof lens, which are described above, are built. In other words, the present invention is also directed to a vibration proof adapter that is attached between a camera body and a lens apparatus, and corrects image blurring caused by vibration applied to at least one of the camera body and the lens apparatus by moving a vibration proof lens within a housing, the vibration proof adapter comprising: a power supply detection device which detects ON/OFF of the power supplied from the camera body; and a locking device which enables the vibration proof lens to move by moving a locking member to a release position if the power supply detection device detects that a power supply is ON while disabling the vibration proof lens to move by moving the locking member to a lock position if the power supply detection device detects that the power supply is OFF.

Moreover, it is also possible to build the locking apparatus of a vibration proof lens for a camera described above and the above-described vibration proof lens in a body of a lens apparatus.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of a television camera apparatus showing an embodiment of the present invention;

FIG. 2 is a side view of the television camera apparatus shown in FIG. 1;

FIG. 3 is a perspective view of a vibration proof adapter according to an embodiment of the present invention viewed from a front plate side;

FIG. 4 is a perspective view of the vibration proof adapter, shown in FIG. 3, viewed from a rear plate side;

FIG. 5 is a sectional view of the vibration proof adapter of the embodiment;

FIG. 6 is a front view showing the supporting structure of a vibration proof lens built in the vibration proof adapter;

FIG. 7 is a block diagram showing a control system for the vibration proof lens;

FIG. 8 is a block diagram showing the whole structure of the vibration proof adapter;

FIG. 9 is a block diagram showing the structure of a locking apparatus of a vibration proof lens according to the present invention;

FIG. 10 is a sectional view showing a principal part of a locking apparatus utilizing a solenoid;

FIG. 11 is a sectional view showing a principal part of a locking apparatus utilizing a solenoid;

FIG. 12 is a sectional view showing a principal part of a locking apparatus utilizing a motor;

FIG. 13 is a sectional view showing a principal part of a locking apparatus utilizing a motor; and

FIG. 14 is a circuit diagram of locking apparatuses shown in FIGS. 12 and 13.

### DETAILED DESCRIPTION OF THE PREFERRED EMBODIMENTS

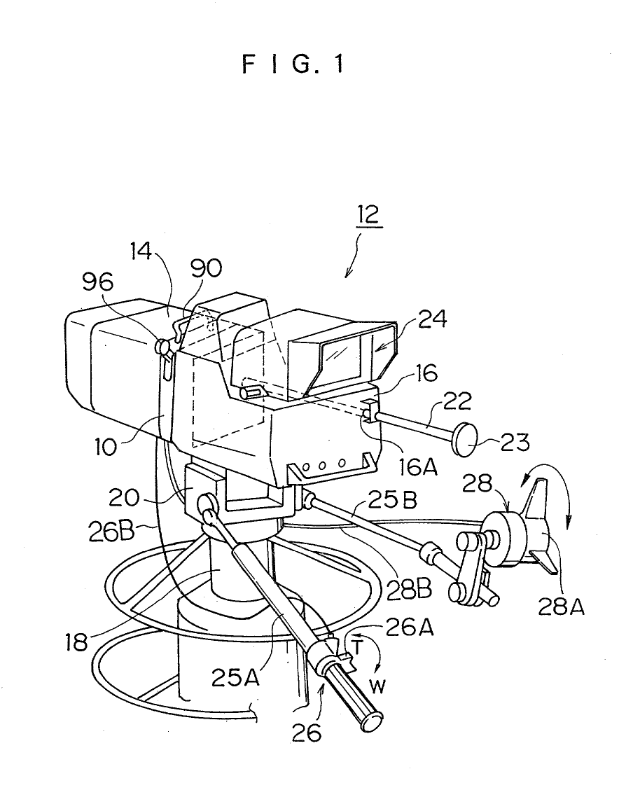

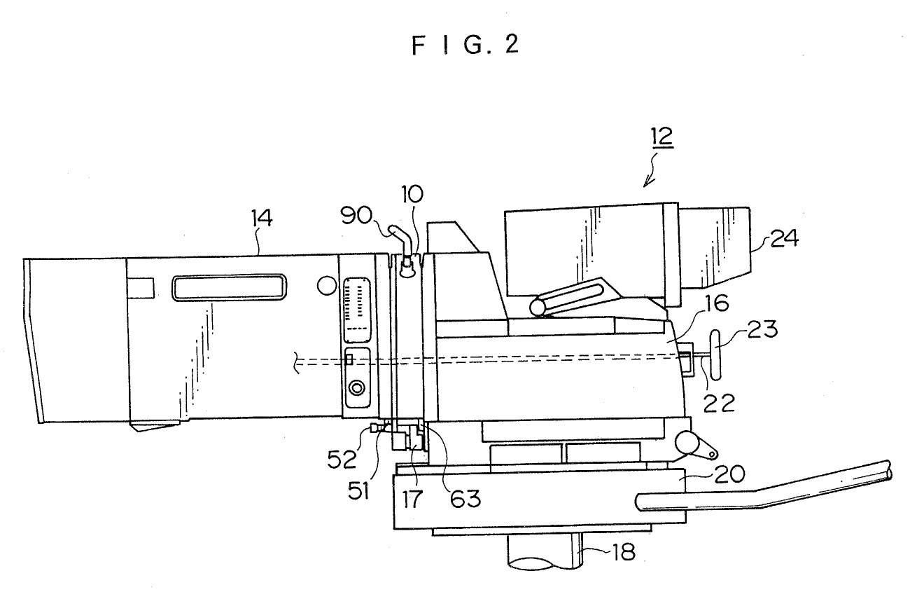

Hereafter, preferred embodiments of the present invention will be described in detail according to accompanying drawings. FIGS. 1 and 2 show a television camera apparatus 12 where a vibration proof adapter 10 according to an embodiment of the present invention is applied. This television camera apparatus 12 is an apparatus where zoom operation and focus operation can be performed in a one-shaft/two-operation mode, and mainly comprise an EFP lens apparatus (hereafter, simply a lens apparatus) 14, a vibration proof adapter 10, and a camera body 16.

The camera body 16 is detachably installed in a universal head 20 provided on an upper part of a tripod or a pedestal 18. A joystick 22 is detachable from the lens apparatus 14, and is provided through the camera body 16 and vibration proof adapter 10. In other words, the joystick 22 is inserted into a joystick through hole 16A formed in the camera body 16, and amend part of the joystick 22 is connected to a lens-driving part of the lens apparatus 14 that is not shown.

A cameraperson can perform zoom operation by holding a grip 23 of the joystick 22 while watching an image displayed in a viewfinder 24 installed on the upper part of the camera body 16 shown in FIG. 1 and performing push/pull operation of the joystick 22, and can perform focus operation by rotationally operating a grip 23 to rotate the joystick 22.

A zoom rate demand 26 and a focus position demand 28 can be installed in pan/tilt sticks 25A and 25B extended from the universal head 20. A cameraperson can perform zoom operation by rotating a thumb ring 26A of the zoom rate demand 26 with his/her thumb, and can perform focus operation by rotating a focus knob 28A of the focus position demand 28.

The zoom rate demand 26 outputs a zoom speed command signal to command zoom speed according to the operation direction and operation quantity of the thumb ring 26A, and a focus position demand 28 outputs a focus position command signal to command a focus position according to a rotational displacement of the focus knob 28A. These command signals are transmitted to the lens apparatus 14 through cables 26B and 28B.

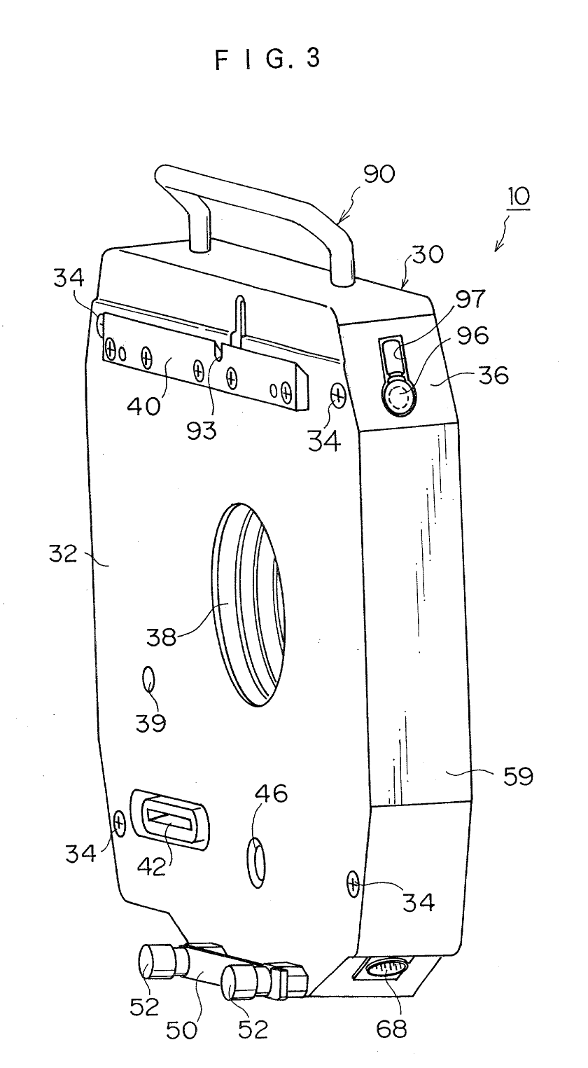

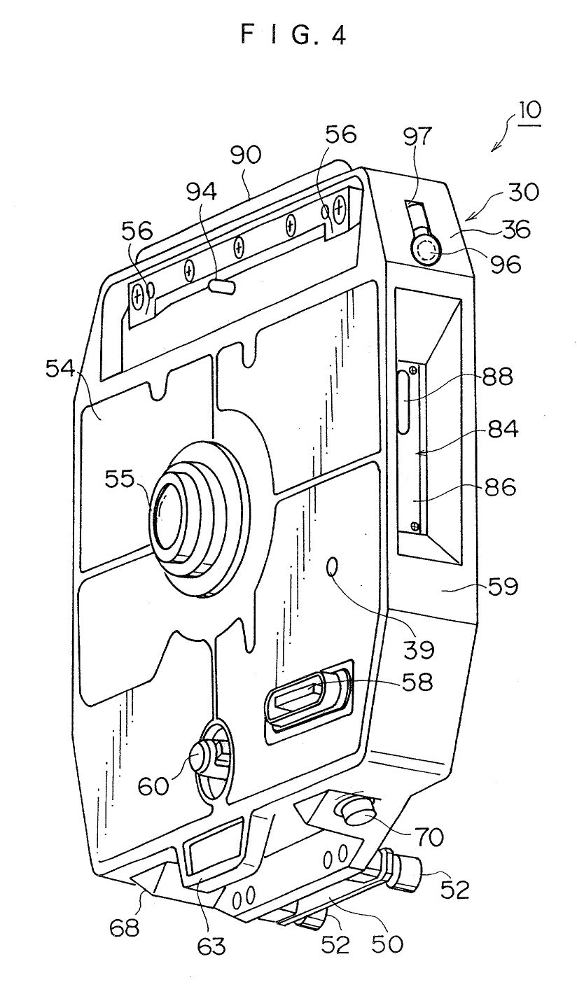

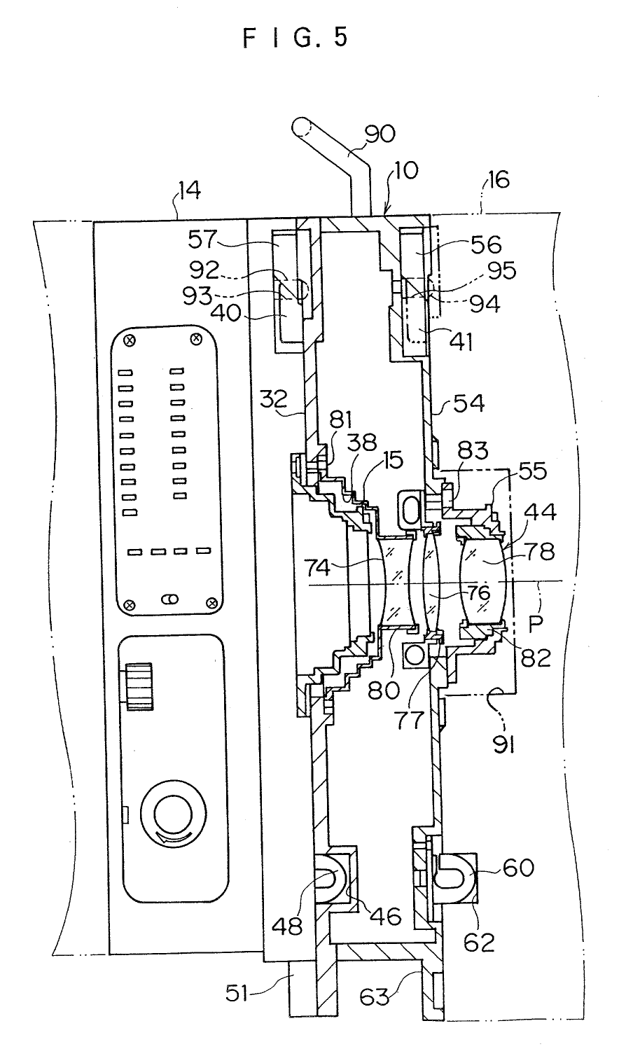

FIGS. 3 and 4 are perspective views to show appearance of vibration proof adapter 10, and FIG. 5 is a sectional view of a principal part with the vibration proof adapter 10 attached. As shown in these drawings, a body housing 30 of the vibration proof adapter 10 is formed in a flat box shape. The body housing 30 comprises a front plate 32 (a side connected to the lens apparatus), a rear plate 54 (a side connected to a camera) and a frame section 36 (a section except the sides connected to the camera and lens apparatus).

The front plate 32 is fixed in the frame section 36 of the body housing 30 with four screws 34, 34, . . . that are screwed in four corners as shown in FIG. 3. A concavity (relief) 38 for relieving a bayonet mount toward the lens apparatus 14 (reference numeral 15 in FIG. 5) is formed in the approximately center portion of the front plate 32. Reference numeral 39 in FIG. 3 denotes a through hole through which the joystick 22 (refer to FIG. 1) passes.

A hook 40 for connecting the lens apparatus 14 is provided in the upper part of the front plate 32. This hook 40 is formed in the same shape as an existing hook (reference numeral 41 in FIG. 5) provided in the camera body 16. As shown in FIG. 3, a handle 90 used in the attaching or detaching operation of the vibration proof adapter 10 is provided in a top face of the frame section 36 of the body housing 30. The attached position of the handle 90 is not limited to the top face of the body housing 30, but a side face is also sufficient.

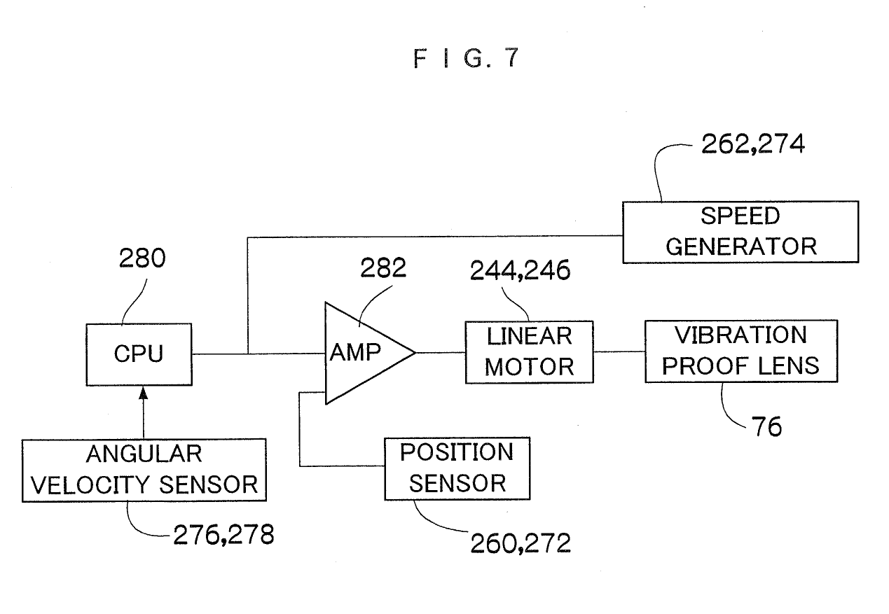

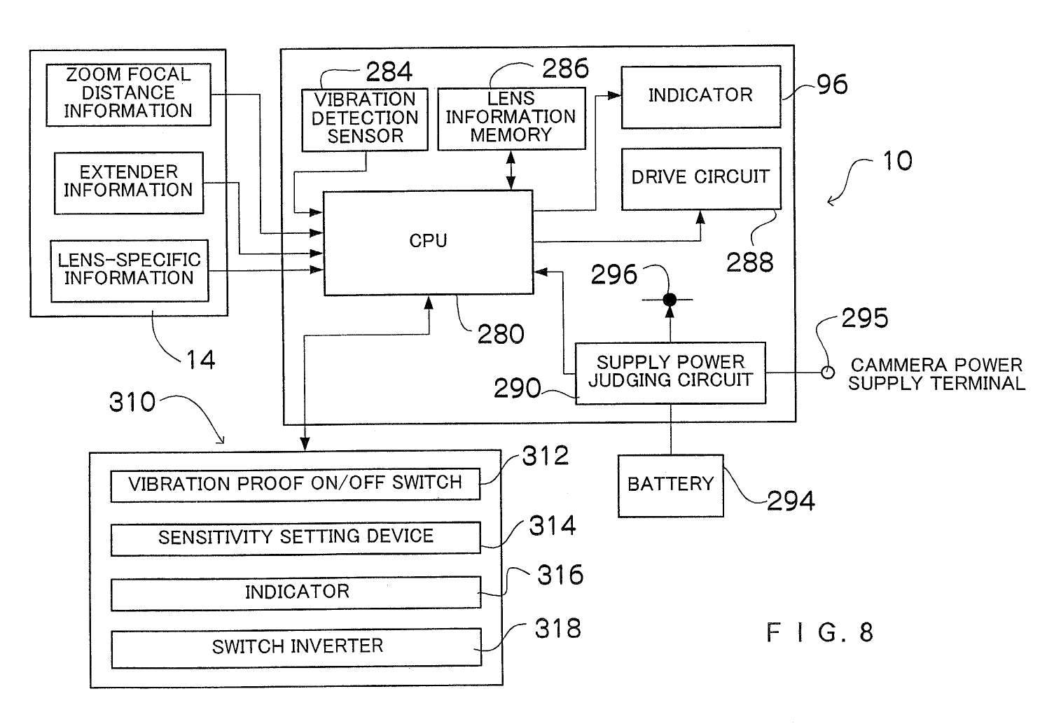

A connector 42 is provided in the lower-left corner section of the front plate 32. When the lens apparatus 14 is connected to the front plate 32, this connector 42 is connected to a connector (not shown) toward the lens apparatus 14. Thereby, focal distance information is provided to a CPU (reference numeral 280 in FIGS. 7 and 8) of the vibration proof adapter 10 from the lens apparatus 14. The CPU 280 sets a transfer of a movable vibration proof correction lens (hereafter, a vibration proof lens) 76 shown in FIG. 5 on the basis of the above-described information.

A concavity 46 is formed in the center of the lower part of the front plate 32 shown in FIG. 3, and a pin (reference numeral 48 in FIG. 5), which has spring property and is provided in a protruding manner at the rear end face of the lens apparatus 14, is fit in this concavity 46. Moreover, as shown in FIG. 3, a sandwich pressure plate 50 is provided in the lower part of the front plate 32. A supporting plate (this is the same as the supporting plate 63 shown in FIG. 4, and is shown with reference numeral 51 in FIG. 5) is held in a sandwiched and pressed manner between the sandwich pressure plate 50 and front plate 32 by inserting the supporting plate 51 toward the lens apparatus 14 between this sandwich pressure plate 50 and front plate 32, fixing the sandwich pressure plate 50 with screws 52 and 52 (refer to FIG. 2).

On the other hand, the rear plate 54 shown in FIG. 4 is integrally formed with the frame section 36, and the camera body 16 (refer to FIG. 2) is connected to the rear plate 54. A bayonet mount 55 is provided in a projecting manner in the approximately center section of the rear plate 54. Although this bayonet mount 55 is used when a hand-held camera such as an ENG camera is connected, when the box-type camera body 16 shown in FIG. 2 is connected, the camera body 16 is connected by using a hook 56 provided in the upper part of the rear plate 54 shown in FIG. 4. In addition, when using a hand-held camera, a lens supporter (not shown) is used. While the rear face of the vibration proof adapter 10 is connected to the front face of the lens supporter, the bayonet mount 55 of the vibration proof adapter 10 is connected to a camera through the lens supporter.

The hook 56 shown in FIG. 4 is formed in the same shape as the existing hook (reference numeral 57 in FIG. 5) provided in the rear end section toward the lens apparatus 14. Reference numeral 94 in FIG. 4 denotes a locator pin. Moreover, the bayonet mount 55 is also constituted in the same structure as the bayonet mount 15 (refer to FIG. 5) of the lens apparatus 14.

A pin 60 which has spring property is provided in a projecting manner in the center of the lower part of the rear plate 54 shown in FIG. 4. This pin 60 is fit in the concavity (reference numeral 62 in FIG. 5) formed in the front end section of the camera body 16. Moreover, this pin 60 is formed in the same shape as the existing pin 48 (refer to FIG. 5) provided in the rear end section of the lens apparatus 14.

As shown in FIG. 4, a supporting plate 63 is formed in a projecting manner in the lower part of the rear plate 54 downward. This supporting plate 63 is held in a sandwiched and pressed manner by a sandwich pressure member (reference numeral 17 in FIG. 2) provided in the camera body 16.

A connector 58 is provided in the lower-right corner section of the rear plate 54 in FIG. 4. When the camera body 16 is connected to the rear plate 54, this connector 58 is connected to a connector (not shown) toward the camera body 16. Electric power is supplied to the vibration proof adapter 10 through the connector 58 from the camera when the vibration proof adapter 10 is connected to the camera body 16. Hence, a power ON/OFF switch is omitted in the vibration proof adapter 10. Electric power is supplied to circuits of the vibration proof adapter 10 when the electric power is applied to the vibration proof adapter 10, the vibration proof lens 76 is automatically unlocked as described later, and further, a vibration detection sensor operates.

In addition, when the power supplied from the camera body 16 is insufficient, the power is supplied to the vibration proof adapter 10 from an external power supply by connecting a cable connector of the AC adapter or a battery, which is not shown, to a power supply connector 68 (refer to FIG. 3) provided in the lower part of the frame section 36.

The connector 58 shown in FIG. 4, and the connector 42 shown in FIG. 3 are connected with a cable (not shown) and is arranged in the body housing 30, and various kinds of information is transmitted through the cable between the lens apparatus 14 and camera body 16. Electric power is supplied to the lens apparatus 14 from the camera body 16.

It is possible to operate ON (enabled)/OFF (disabled) of the vibration proof function in the vibration proof adapter 10 with a controller (shown with reference numeral 310 in FIG. 8) connected to the controller connector 70 (refer to FIG. 4), which is provided in the lower part of the body housing 30, through a cable (not shown). A momentary switch with an indicator which indicates the ON/OFF status of the vibration proof function can be attached in the controller 310 provided near a cameraperson's fingers (near the end section of the pan/tilt operation rods 25A and 25B, etc.). As an example of an operating method, it is possible to turn on the vibration proof function only when the momentary switch is being depressed, and to turn off the vibration proof function when the switch is released from the depression. Moreover, it is also good to provide a changeover switch such as a toggle switch in parallel to this, and to switch a function of the momentary switch by switching this change-over switch so that the vibration proof function is tuned off only when the momentary switch is being depressed, and that the vibration proof function is turned on when the depression of the switch is performed.

Thus, an inverting function is provided in the ON/OFF switch of the vibration proof function, and makes it possible to select a mode of turning on the vibration proof function only when the switch is being depressed, or a mode of turning off the vibration proof function only when the switch is being depressed. This is because there are two operation modes according to a cameraperson and an image taking scene: a mode that the vibration proof function is tuned on when necessary; and a mode that the vibration proof function is always turned on, and is tuned off only when required.

The ON/OFF status of the vibration proof function is displayed by indicators 96, 96 provided in the upper parts of the right and left sides of the frame section 36 shown in FIGS. 3 and 4. The indicators 96, 96 are contained in the concavities 97 and 97 of the body housing 30, and are projected outward from the body housing 30 in use.

In addition, a concavity 84 is formed in the right-hand side of the frame section 36 shown in FIG. 4, and a cover plate 86 is detachably attached in this concavity 84. A switch group, not shown, is arranged in the depth of the cover plate 86. This switch group functions as a lens selective switch, pan/tilt control switches and a test mode switch. A rubber cap 88 blocks an opening section formed in the cover plate 86. It becomes possible to operate the switch group because a part of the above-described switch group is exposed by detaching this rubber cap 88.

A method of mounting the vibration proof adapter 10 constituted as described above will be described. The vibration proof adapter 10 is connected by making the hook 56 of the vibration proof adapter 10 engage with the hook 41 of the camera body 16 while making the hook 57 of the lens apparatus 14 engage with the hook 40 of the vibration proof adapter 10, as shown in FIG. 5. The tapered face formed at about 45 degrees of tilt angle is formed in each of these hooks 40, 57, 41 and 56, and the vibration proof adapter 10 is connected by making these tapered faces engaged with each other. In addition, the bayonet mount 55 is contained in the concavity (mount relief) 91 formed in the camera body 16.

The locator pin 94 is provided in a projecting manner in the hook 56 of the vibration proof adapter 10. This pin 94 is engaged with a groove 95 formed in the center section of the hook 41 in the camera body 16. In the connection of the vibration proof adapter 10 and the camera body 16, the hook 41 in the camera apparatus is made to be engaged with the hook 56 in the adapter. Then, the optical axes of the camera body 16 and the vibration proof adapter 10 coincide with each other in the vertical direction. In addition, when the pin 94 is made to be engaged with the groove 95, both optical axes coincide with each other in the horizontal direction.

On the other hand, a locator pin 92 is provided in a projecting manner in the hook 57 of the lens apparatus 14. This pin 92 is engaged with a groove 93 formed in the center section of the hook 40 in the vibration proof adapter 10. In the connection of the vibration proof adapter 10 and the lens apparatus 14, the hook 40 in the vibration proof adapter 10 is made to be engaged with the hook 57 in the lens apparatus 14. Then, the optical axes of the lens apparatus 14 and the vibration proof adapter 10 coincide with each other in the vertical direction. When the groove 93 is made to be engaged with the pin 92, both optical axes coincide with each other in the horizontal direction. Thereby, since both optical axes coincide with each other, respective optical axes of the vibration proof adapter 10, lens apparatus 14, and camera body 16 coincide with one another.

Then, while fixing the supporting plate 51 of the lens apparatus 14 by fastening the plate 51 with the sandwich pressure plate 50 of the vibration proof adapter 10, the supporting plate 63 of the vibration proof adapter 10 is fixed with the sandwich pressure member 17 of the camera body 16. Hence, the vibration proof adapter 10 is mounted in the lens apparatus 14 and camera body 16.

As shown in FIG. 5, a vibration proof correction lens group 44 is provided inside the vibration proof adapter 10. The vibration proof correction lens group 44 comprises a first fixed lens 74, a vibration proof lens (movable lens) 76 and a second fixed lens 78. The first fixed lens 74 is fixed in a lens frame 80. The lens frame 80 is a member integrally formed with a part constituting the concavity 38, and is fixed in the front plate 32 by screws 81. The second fixed lens 78 is fixed in a lens frame 82 provided inside a bayonet mount 55, and the bayonet mount 55 is fixed to the rear plate 54 with screws 83.

The vibration proof lens 76 is held by the lens frame 77, and is arranged in the space that is enclosed by the first fixed lens 74 and the second fixed lens 78. Hence, dust etc. does not adhere to the vibration proof lens 76 but high-performance lens conditions can be maintained. The lens frame 77 is connected to a vibration proof mechanism, and is moved within a plane orthogonal to an optical axis P by this vibration proof mechanism to substantially correct image blurring.

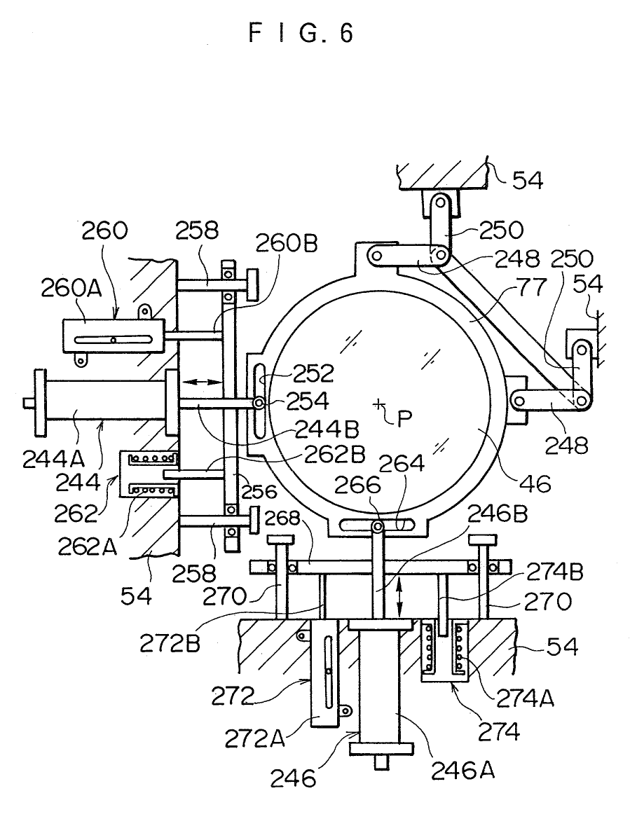

Next, an example of the vibration proof mechanism applied to the vibration proof adapter 10 will be described. FIG. 6 is a front view showing the supporting structure of the vibration proof lens 76. As shown in the figure, the vibration proof lens 76 is moved in the direction of compensating image blurring in the plane orthogonal to the image-taking optical axis P by linear motors 244 and 246. The vibration proof lens 76 is movably supported inside the rear plate 54 through a parallel link mechanism that has four arms 248, 248, 250 and 250.

The linear motor 244 moves the vibration proof lens 76 in a horizontal direction in FIG. 6, and comprises a motor body 244A and a rod 244B. The motor body 244A is fixed to the rear plate 54, and the tip of the rod 244B is engaged with a slot 252 of the lens frame 77 through the roller 254. The slot 252 is formed in the left-hand section of the lens frame 77 in the vertical direction in this drawing, and is engaged with the roller 254 movably in the vertical direction in FIG. 6 relatively.

If the driving force of a motor body 244A activates the extensible operation of the rod 244B, the vibration proof lens 76 is pushed or pulled by the rod 244B, and moves to horizontal direction in FIG. 6.

A connection frame 256 is fixed to the rod 244B of the linear motor 244. This connection frame 256 is arranged in the vertical direction in FIG. 6, the rod 244B is fixed in a center section, and the upper and lower end sections are slidably supported by linear guides 258 and 258, respectively. The linear guides 258 and 258 are provided in parallel with the rod 244B, and when the rod 244B is extended and contracted, the connection frame 256 moves in parallel in the longitudinal direction in FIG. 6 while keeping the posture.

The tip of a contact needle 260B for detection of a position sensor 260 is abutted with pressure, to the connection frame 256. As for a position sensor 260, a sensor body 260A is fixed to the rear plate 54 at a position where a contact needle 260B for detection becomes parallel to the rod 244B, and detects the transfer of the connection frame 256 which moves in parallel with extending and contracting operation of the rod 244B.

A bobbin 262A constitutes a speed generator 262, and a core 262B constitutes a speed generator 262. This core 262B is fixed to the connection frame 256.

On the other hand, the linear motor 246 moves the vibration proof lens 76 in the vertical direction in FIG. 6, and comprises a motor body 246A and a rod 246B. The motor body 246A is fixed to the rear plate 54, and the tip of the rod 246B is engaged with a slot 264 of the lens frame 77 through the roller 266. The slot 264 is formed in the lower section of the lens frame 77 in the horizontal direction in FIG. 6, and is engaged with the roller 266 movably in the horizontal direction in FIG. 6 relatively.

If the driving force of a motor body 246A activates the extensible operation of the rod 246B, the vibration proof lens 76 is pushed or pulled by the rod 246B, and moves in the vertical direction in FIG. 6.

A connection frame 268 is fixed to the rod 246B of the linear motor 246. In FIG. 6, the connection frame 268 is arranged in the horizontal direction, the rod 246B is fixed to its center section, and the right and left end sections are slidably supported by linear guides 270 and 270, respectively. The linear guides 270 and 270 are provided in parallel with the rod 246B, and when the rod 246B is extended and contracted, the connection frame 268 moves in parallel in the vertical direction while keeping the posture.

The tip of a contact needle 272B for detection of a position sensor 272 is abutted with pressure, to the connection frame 268. As for the position sensor 272, a sensor body 272A is fixed to the rear plate 54 at a position where a contact needle 272B for detection becomes parallel to the rod 246B, and the position sensor 272 detects a transfer of the connection frame 268 which moves in parallel with extending and contracting operation of the rod 246B.

A bobbin 274A constitutes a speed generator 274, and a core 274B constitutes a speed generator 274. This core 274B is fixed to the connection frame 268.

In addition, the internal structure of the vibration proof adapter 10 is not limited to the form shown in FIG. 6, but various forms are possible for the concrete structure for suitably moving the vibration proof lens 76 with a drive device such as an actuator.

FIG. 7 is a block diagram showing a drive control system for the vibration proof lens 76. Angular velocity sensors 276 and 278 shown in this drawing are arranged inside the vibration proof adapter 10 (inside the rear plate 54). One angular velocity sensor 276 detects vibration of a horizontal component of vibration transmitted to the television camera apparatus 12, and this detected information is supplied to the CPU 280.

The CPU 280 calculates the transfer for compensation in the horizontal direction, which should be given to the vibration proof lens 76, on the basis of the information accepted from the angular velocity sensor 276. After this signal that shows the transfer for compensation in the horizontal direction is amplified by an amplifier 282, it is outputted to the linear motor 244. The linear motor 244 operates so that only the amount according to the command signal from the CPU 280 may extend or contract the rod 244B, and moves the vibration proof lens 76 to a position for compensating image blurring. Thereby, the vibration component in the horizontal direction is offset by the movement of the vibration proof lens 76, and image blurring in the horizontal direction is suppressed.

The position sensor 260 detects the movement position of the connection frame 56 at the time of the movement of the vibration proof lens 76 in the horizontal direction. The position signal detected by the position sensor 260 is compared with the signal that shows the transfer for compensation that is outputted from the CPU 280. Then, the feedback control of the linear motor 244 is performed so that the vibration proof lens 76 may be located in the position corresponding to a transfer for compensation.

Similarly, another angular velocity sensor 278 detects vibration of a vertical component of vibration transmitted to the television camera apparatus 12, and this detected information is supplied to the CPU 280. The CPU 280 calculates the transfer for compensation in the vertical direction, which should be given to the vibration proof lens 76, on the basis of the information accepted from the angular velocity sensor 278. This signal that shows the transfer for compensation in the vertical direction is outputted through the amplifier 282 to the linear motor 246. The linear motor 246 operates so that only the amount according to the command signal from the CPU 280 may extend or contract the rod 246B, and moves the vibration proof lens 76 to a position for compensating image blurring. Thereby, the vibration component in the vertical direction is offset by the movement of the vibration roof lens 76, and image blurring in the vertical direction is suppressed.

The position sensor 272 detects the movement position of the connection frame 68 at the time of the movement of the vibration proof lens 276 in the vertical direction. The position signal detected is compared with the signal that shows the transfer for compensation that is outputted from the CPU 280. Then, the feedback control of the linear motor 246 is performed so that the vibration proof lens 276 may be located in the position corresponding to the transfer for compensation.

FIG. 8 is a block diagram showing the whole structure of the vibration proof adapter 10. The vibration proof adapter 10 comprises a vibration detection sensor 284, lens information memory 286, a drive circuit 288, a supply power judging circuit 290 and the CPU 280. The vibration detection sensor 284 is equivalent to the angular velocity sensors 276 and 278 described in FIG. 7. The drive circuit 288 shown in FIG. 8 is a circuit block for driving the vibration proof lens 76, and includes the amplifier 282 and linear motors 244 and 246 described in FIG. 7.

As shown in FIG. 8, the power of the vibration proof adapter 10 is supplied from a camera power supply terminal 295 of the camera body 16. Moreover, an external power supply such as a battery 294 can also be connected. A supply power judging circuit 290 judges a supply source, and automatically switches a power supply source, supplying power to the power supply terminal 296 inside the vibration proof adapter 10, to either the camera power supply terminal 295 or the battery 294.

A zoom position (focal distance presently set) of the lens apparatus 14 is always detected by a detection sensor such as a potentiometer (not shown), and the focal distance information is reported to the CPU 280 of the vibration proof adapter 10. Moreover, the information that shows the status (presence and extender magnification of the extender) of an extender of the lens apparatus 14 (extender information), and information such as model information and optical performance data (lens-specific information including lens magnification) of the lens apparatus 14 is communicated to the CPU 280 of the vibration proof adapter 10. The information is stored in lens information memory 286. In addition, the lens-specific information is stored in ROM and the like of the lens apparatus 14. The CPU 280 reads data from the lens information memory 286 if needed, and performs calculation for the control of the vibration proof lens 76.

A controller (remote operation unit) 310 is connected to the vibration proof adapter 10. The controller 310 has a vibration proof ON/OFF switch 312 for selecting the ON/OFF status of the vibration proof function, a sensitivity setting device 314 which adjusts the sensitivity of the vibration proof function, an indicator 316 which indicates the ON/OFF status of the vibration proof function, and a switch inverter 318 which inverts the function of the vibration proof ON/OFF switch 310.

When the vibration proof function is turned on with the vibration proof ON/OFF switch 312, the indicator 316 of the controller 310 and the indicator 96 of the vibration proof adapter 10 perform the indication which shows that the vibration proof function is in the ON status.

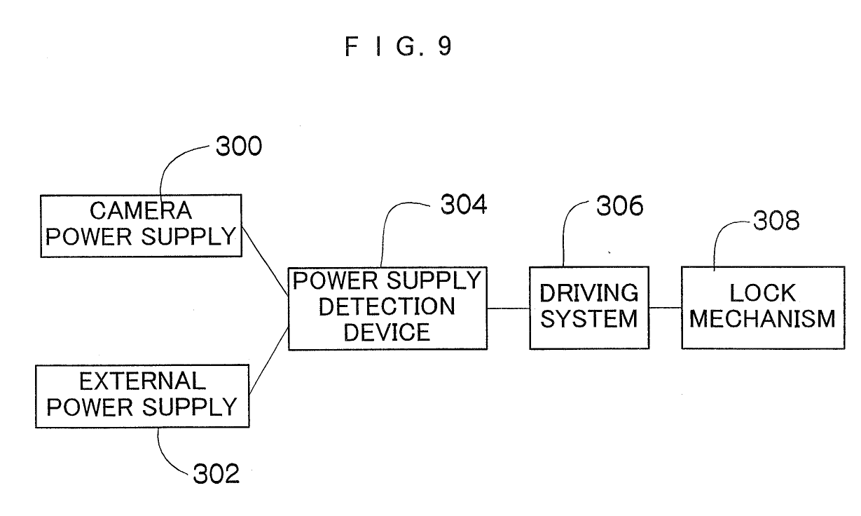

Next, a locking apparatus of the vibration proof lens 76 will be described. FIG. 9 is a block diagram showing the structure of the locking apparatus according to the present invention. A power supply detection device 304 detects that a camera power supply 300 or an external power supply 302 is connected and power is applied to vibration proof circuits, and activates a driving system 306 such as an actuator to release a lock mechanism. On the contrary, when detecting that power supply becomes OFF, the power supply detection device 304 activates the lock mechanism through the driving system 306 to lock the vibration proof lens 76.

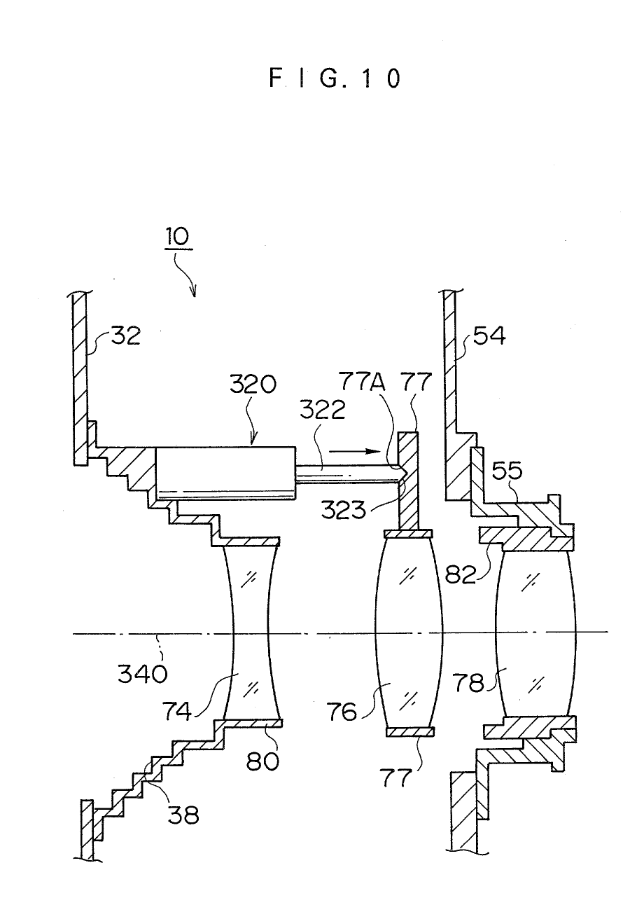

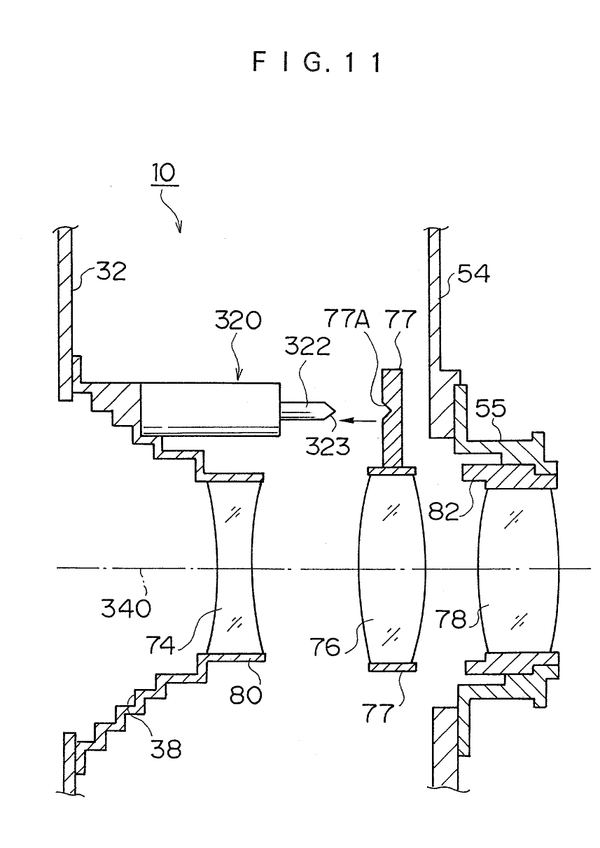

For example, as a concrete device which automatically locks or unlocks a lock mechanism by interlocking with ON/OFF of a power supply, as shown in FIGS. 10 and 11, there is an aspect of utilizing a solenoid.

FIGS. 10 and 11 are sectional views of a principal part showing a locking apparatus of the vibration proof lens 76. FIG. 10 shows the state that the vibration proof lens 76 is locked (this is called “locked state”), and FIG. 11 shows the state that the vibration proof lens 76 is unlocked (this is called “locked state”).

As shown in these figures, a rectilinear type solenoid 320 is provided in the vibration proof adapter 10, and a moving iron core (plunger) 322 of the solenoid 320 fixes (locks) the lens frame 77 of the vibration proof lens 76. A taper 323 is formed in an end part of the plunger 322, and a taper groove 77A corresponding to the taper 323 of the plunger 322 is formed in the lens frame 77. As shown in FIG. 10, amend part of the plunger 322 is engaged with the taper groove 77A of the lens frame 77 when the solenoid 320 is not energized (at power-down), and fixes the lens frame 77 in a predetermined position (for example, a center position on such setting that an optical axis of the vibration proof lens 76 coincides with an optical axis 340 of the first and second fixed lenses 74 and 78).

Moreover, as shown in FIG. 11, when the solenoid 320 is energized (at power-up), a magnetic field occurs in a coil core, and hence the plunger 322 is attracted into a cylinder (frame core) for the taper 323 to leave the taper groove 77A. Owing to this, the vibration proof lens 76 is unlocked and becomes movable in a plane orthogonal to the optical axis 340. After that, when power is shut off, the plunger 322 is returned again to the state shown in FIG. 10, and the vibration proof lens 76 is automatically locked.

According to a locking apparatus having the above structure, lock/unlock operation is automatically performed by interlocking with ON/OFF of a power supply, and hence a user's lock/unlock operation is unnecessary. Hence, it is possible to surely lock the vibration proof lens 76 in transportation (at power-down).

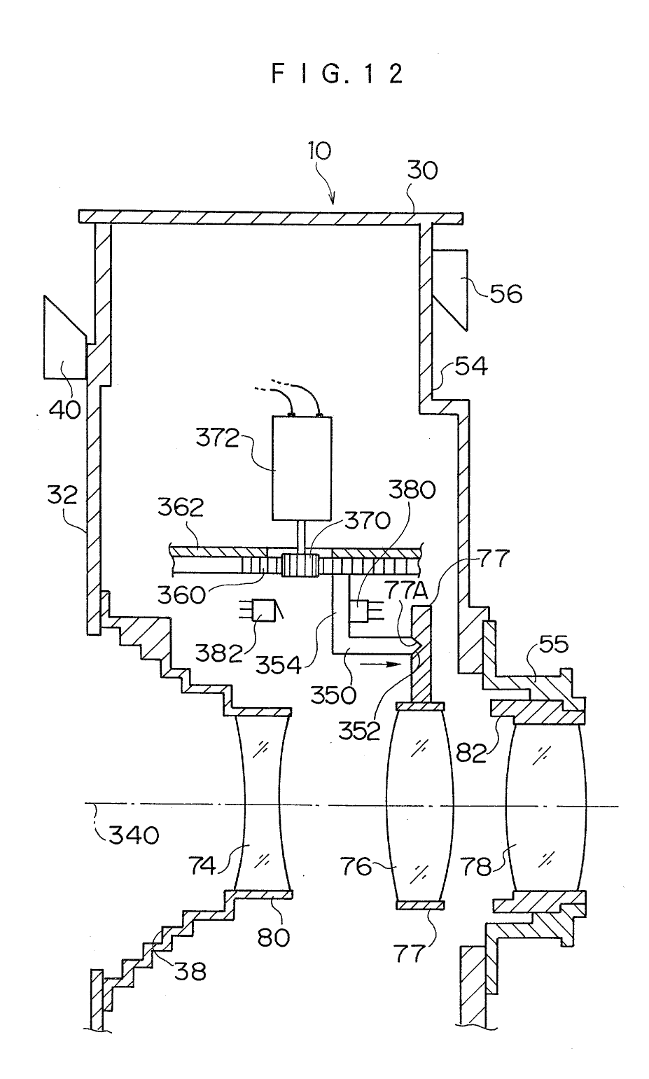

Next, other embodiments of the locking apparatus will be described using FIGS. 12 to 14.

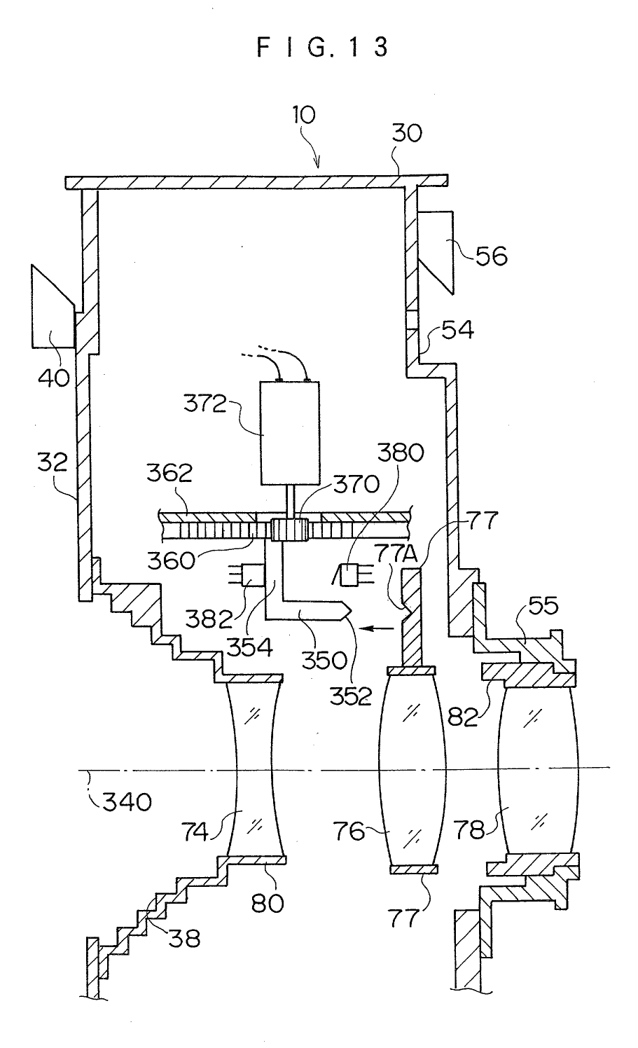

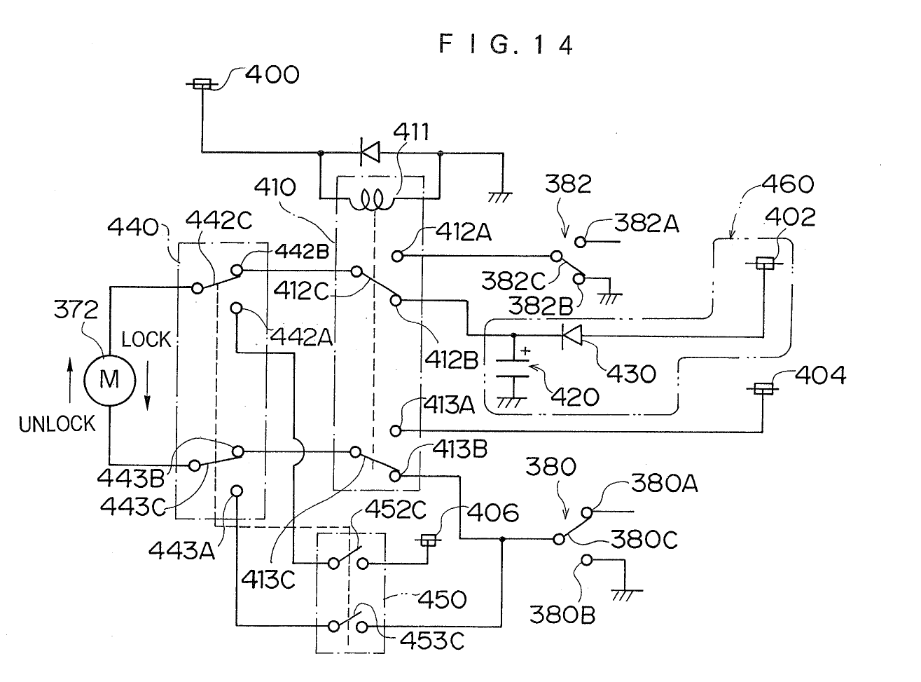

FIGS. 12 and 13 are sectional views of a principal part showing the structure of a locking apparatus according to another embodiment, FIG. 12 shows the locked state, and FIG. 13 shows the unlocked state. Moreover, FIG. 14 is a circuit diagram of this locking apparatus. As shown in FIG. 12, a rack 360 where a lock pin 350 is fixedly provided, a motor 372 rotating a pinion 370 engaging with the rack 360, and detection switches 380 and 382 detecting positions of the lock pin 350 (a lock position/a release position) are provided inside the vibration proof adapter 10.

The rack 360 is movably supported in the horizontal direction in FIG. 12 by a guide member 362. Since the turning force of the motor 372 is transferred to the rack 360 through the pinion 370, the lock pin 350 integrally formed with the rack 360 moves in the horizontal direction in FIG. 12. The moving direction of the lock pin 350 can be changed by changing the rotary direction of the motor 372.

A taper 352 is formed in an end part of the lock pin 350, and a taper groove 77A corresponding to the taper 352 of the lock pin 350 is formed in the lens frame 77. The vibration proof lens 76 is fixed (locked) in a predetermined position by engaging the taper 352 of the lock pin 350 with the taper groove 77A of the lens frame 77 through driving the motor 372. At this time, a column section 354 of the lock pin 350 contacts a detection switch 380 (hereinafter referred to as a lock detection switch). When the column section 354 contacts the lock detection switch 380, the lock detection switch 380 operates to stop the motor 372. In addition, as for the driving electric power of the motor 372 to be necessary for lock operation, the discharge of a capacitor charged beforehand at power-up (shown as reference numeral 420 in FIG. 14) is utilized.

When power is applied in the locked state shown in FIG. 12, the motor 372 turns in the direction inverted from that at lock time to move the lock pin 350 in the left direction as shown in FIG. 13. Since the lock pin 350 leaves the taper groove 77A of the lens frame 77, the vibration proof lens 76 is unlocked. When the lock pin 350 moves to a predetermined release position, the column section 354 of the lock pin 350 contacts the detection switch 382 (hereinafter referred to as a release detection switch), and the release detection switch 382 operates to stop the motor 372.

This locking apparatus has the circuit configuration shown in FIG. 14. In addition, FIG. 14 shows a locked state (a state at power-down). Predetermined voltages are applied to power supply terminals 400, 402, 404 and 406 by the power being supplied from the camera body 16.

An exciting coil 411 of an electromagnetic switch 410 is connected to the power supply terminal 400. The electromagnetic switch 410 has two moving armatures (common terminals) 412C and 413C interlocking with each other, and at power-down, the first moving armature 412C contacts with a contact terminal 412B, and the second moving armature 413C contacts with a contact terminal 413B. When power is applied and current flows in an exciting coil 411, connection points of the first moving armature 412C and the second moving armature 413C are switched to contact terminals 412A and 413A, respectively.

A positive electrode terminal of a capacitor 420 with large capacity is connected to the terminal 412B, and a negative electrode terminal of the capacitor 420 is connected to the ground (GND). Since the power supply terminal 402 is connected to the positive electrode terminal of the capacitor 420 through a diode 430, the capacitor 420 is charged at power-up.

A contact terminal 412A of the electromagnetic switch 410 is connected to a moving armature (common terminal) 382C of the release detection switch 382. When the release detection switch 382 does not detect an unlocked state, the moving armature 382C contacts with the ground terminal 382B. In addition, when the column section 354 of the lock pin 350 contacts the release detection switch 382 as shown in FIG. 13, a connection point of the moving armature 382C is switched to an open terminal 382A.

The contact terminal 413B to which the second moving armature 413C of the electromagnetic switch 410 is selectively connected is connected to the moving armature (common terminal) 389C of the lock detection switch 380, and, when the lock detection switch 380 detects a locked state, the moving armature 380C contacts the open terminal 380A. In addition, as shown in FIG. 12, when the column section 354 of the lock pin 350 leaves the lock detection switch 380 by unlock operation, a connection point of the moving armature 380C is switched to the ground terminal 380B. Moreover, the contact terminal 413A, where the second moving armature 413C is connected when the electromagnetic switch 411 is energized, is connected to the power supply terminal 404.

The moving armatures 412C and 413C of the electromagnetic switch 410 are connected to electrodes of the motor 372 respectively through an electric switch 440. The electric switch 440 is a manual switch (a forced lock switch) to realize a locked state at power-up, if needed, and operates by interlocking with an electric switch 450 according to a user's operation. An action of the forced lock switch will be described later. As shown in FIG. 14, usually, the moving armatures 442C and 443C of the electric switch 440 contact the contact terminals 442B and 443B, respectively, where the moving armatures 412C and 413C of the electromagnetic switch 410 are connected, respectively. Moreover, the moving armatures 452C and 453C of the electric switch 450 become open (OFF) together.

The operation of circuits constituted as descried above will be described. When power is applied, current flows in the coil 411 of the electromagnetic switch 410, the moving armatures 412C and 413C contact the contact terminals 412A and 413A, respectively. Owing to this, a voltage is applied to the motor 372 from the power supply terminal 404, and the motor 372 turns in the release direction. Moreover, during this power-up, the capacitor 420 is charged by the voltage supplied from the power supply terminal 402. As shown in FIG. 13, since the turning force of the motor 372 is transferred to the rack 360 through the pinion 370, the lock pin 350 moves in the release direction. When the column section 354 of the lock pin 350 leaves the lock detection switch 380, the moving armature 380C of the lock detection switch 380 contacts the ground terminal 380B.

When the column section 354 contacts the release detection switch 382 by the lock pin 350 moving to a predetermined release position, a connection point of the moving armature 382C of the release detection switch 382 is switched to the open terminal 382A to stop the motor 372. In this manner, the vibration proof lens 76 is automatically unlocked at power-up.

When power is shut off, the moving armatures 412C and 413C of the electromagnetic switch 410 contact the contact terminals 412B and 413B, respectively. Owing to this, the voltage charged in the capacitor 420 is applied to the motor 372, which turns in the lock direction (the direction reverse to the release direction). When the column section 352 contacts the lock detection switch 380 by the lock pin 350 moving in a predetermined lock position owing to the turning force of the motor 372, a connection point of the moving armature 380C of the lock detection switch 380 is switched to the open terminal 380A to stop the motor 372. In this manner, the vibration proof lens 76 is automatically locked at power-down.

Next, a device which forcibly locks the vibration proof lens 76 at power-up, if needed, will be described. As shown in FIG. 14, manual switches 440 and 450 that the user can operate at need are provided in this locking apparatus.

When the user operates the electric switch 450 (or 440) (forced lock ON), both moving armatures 452C and 453C of the electric switch 450 become closed (ON). Hence, by interlocking with this, the moving armatures 442C and 443C of the electric switch 440 are connected to the terminals 442A and 443A, respectively. The terminal 442A is connected to the power supply terminal 406 through the moving armature 452C of the electric switch 450, and the terminal 443A is connected to the common terminal (moving armature 380C) of the lock detection switch 380 through the moving armature 453C of the electric switch 450.

In this manner, a voltage is applied from the power supply terminal 406 to the motor 372, which turns in the lock direction. When the column section 352 contacts the lock detection switch 382 by the lock pin 350 moving in a predetermined lock position owing to the turning force of the motor 372, a connection point of the moving armature 380C of the lock detection switch 380 is switched to the open terminal 380A to stop the motor 372. Thus, since it is possible to lock a vibration proof lens 76 even at power-up, if needed, this is convenient in manufacturing adjustment work etc.

As a power supply device which activates the motor 372 at power-down, in FIG. 14, the capacitor 420 is utilized, but an aspect of substituting the power supply section 460 including the capacitor 420 (portion surrounded with alternate long and two short dashes lines in FIG. 14) with cell is also possible.

In the above-described embodiments, the locking apparatus of the vibration proof lens 76 that is built in the vibration proof adapter 10 is described. However, the scope of the present invention is not limited to this, and similar locking apparatuses can also be applied to the models where each vibration proof lens is built in a lens apparatus body.

As described above, according to the present invention, it is not necessary for the user to operate a lock mechanism since a locking member of a vibration proof lens is automatically driven to a release position/lock position by interlocking with ON/OFF of a power supply. Hence, not only operability improves, but also misoperation at the time of conveyance is prevented, and hence safety improves.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A locking apparatus for locking a vibration proof lens which is moved to correct image blurring caused by vibration applied to a camera, the locking apparatus comprising:
a power supply detection device which detects whether a power supply is connected to a drive circuit activating the vibration proof lens; and
a locking device which enables the vibration proof lens to move by moving a locking member to a release position if the power supply detection device detects that the power supply is ON while disabling the vibration proof lens to move by moving the locking member to a lock position if the power supply detection device detects that the power supply is OFF.

2. The locking apparatus according to claim 1, further comprising a forcibly locking device which prohibits unlock operation of the locking device in response to a user's operation at power-up, and at the same time, forcedly achieves a locked state by moving the locking member to the lock position.

3. The locking apparatus according to claim 1, wherein the locking device comprises a solenoid used as an electrically driving device to move the locking member.

4. The locking apparatus according to claim 3, further comprising a forcibly locking device which prohibits unlock operation of the locking device in response to a user's operation at power-up, and at the same time, forcedly achieves a locked state by moving the locking member to the lock position.

5. The locking apparatus according to claim 1, wherein the locking device comprises:
a motor used as electrically driving device which moves the locking member; and
one of a capacitor and a battery used as an electric power-supplying device which activates the motor at power-down.

6. The locking apparatus according to claim 5, further comprising a forcibly locking device which prohibits unlock operation of the locking device in response to a user's operation at power-up, and at the same time, forcedly achieves a locked state by moving the locking member to the lock position.

7. A lens apparatus including the locking apparatus and the vibration proof lens according to claim 1.

8. A lens apparatus including the locking apparatus and the vibration proof lens according to claim 2.

9. A lens apparatus including the locking apparatus and the vibration proof lens according to claim 3.

10. A lens apparatus including the locking apparatus and the vibration proof lens according to claim 4.

11. A lens apparatus including the locking apparatus and the vibration proof lens according to claim 5.

12. A lens apparatus including the locking apparatus and the vibration proof lens according to claim 6.

13. A vibration proof adapter that is attached between a camera body and a lens apparatus, and corrects image blurring caused by vibration applied to at least one of the camera body and the lens apparatus by moving a vibration proof lens within a housing, the vibration proof adapter comprising:
a power supply detection device which detects ON/OFF of a power supply from the camera body; and
a locking device which enables the vibration proof lens to move by moving a locking member to a release position if the power supply detection device detects that the power supply is ON while disabling the vibration proof lens to move by moving the locking member to a lock position if the power supply detection device detects that the power supply is OFF.
